(19) United States
(12) Patent Application Publication
(10) Pub. No.: US 2021/0144288 A1
(43) Pub. Date: May 13, 2021

(54) DISPLAY SYSTEM AND DISPLAY SYSTEM CONTROL METHOD

(71) Applicant: Sharp NEC Display Solutions, Ltd, Tokyo (JP)

(72) Inventor: Ryoji TAKAHASHI, Tokyo (JP)

(21) Appl. No.: 17/152,406

(22) Filed: Jan. 19, 2021

Related U.S. Application Data
(63) Continuation of application No. PCT/JP2018/028065, filed on Jul. 26, 2018.

(51) Int. Cl. H04N 5/235; H04N 5/225; G09G 3/32

(52) U.S. Cl. CPC H04N 5/2354; H04N 7/18; G09G 3/32; H04N 5/2256

(57) ABSTRACT

According to an aspect of the present invention, there is provided a display system including a camera and a display device configured to reproduce a display video and having an infrared light source, the display system including an infrared luminance control unit configured to control luminance of the infrared light source in accordance with a state of a video captured by the camera.

### TECHNICAL FIELD

The present invention relates to a display system and a display system control method.

### BACKGROUND ART

At present, infrared cameras are installed in various places for the purpose of monitoring and investigation.

For example, in an advertisement information distribution system described in Patent Literature 1, an advertisement display device constituting the system includes an infrared camera configured to execute infrared monitoring for monitoring a status of human beings in the vicinity of a display.

Also, in a game system described in Patent Literature 2, a commercial game device constituting the system includes a distance measurement device, which includes an infrared light irradiation device configured to radiate infrared light in front of the device so that a distance to a physical object in front of the device is measured and an infrared camera configured to photograph infrared light reflected by the physical object.

Normally, an infrared illumination device is embedded in an infrared camera and photography can be executed within an illumination range of the infrared illumination device.

### CITATION LIST

### Patent Literature

### [Patent Literature 1]

Japanese Unexamined Patent Application, First Publication No. 2006-99722

### [Patent Literature 2]

Japanese Unexamined Patent Application, First Publication No. 2016-123517

### SUMMARY OF INVENTION

### Technical Problem

However, the infrared illumination device embedded in the infrared camera has a limit in the brightness of illumination due to size limitation and it may be difficult to capture a clear video with the infrared camera. For example, when an image of a person's face is analyzed to obtain a line of sight, it is necessary to capture a clear video by illuminating a target person's face with the infrared illumination device so that the brightness becomes appropriate to improve the accuracy of a result.

Also, if a size of the illumination device is increased to increase the brightness of the illumination of the infrared camera, it is easy for a monitoring and investigation target to notice the presence of the camera and natural monitoring and investigations become difficult.

The present invention has been made in view of the above-described circumstances and an objective of the present invention is to provide a display system and a display system control method for enabling an infrared camera to capture a clear video.

### Solution to Problem

According to an aspect of the present invention for solving the above-described problem, there is provided a display system including a camera and a display device configured to reproduce a display video and having an infrared light source, the display system including: an infrared luminance control unit configured to control luminance of the infrared light source in accordance with a state of a video captured by the camera.

Also, according to an aspect of the present invention, there is provided a method of controlling a display system including a camera and a display device configured to reproduce a display video and having an infrared light source, wherein the display device is configured to include an infrared luminance control unit and wherein the infrared luminance control unit controls luminance of the infrared light source in accordance with a state of a video captured by the camera.

### Advantageous Effects of Invention

According to an aspect of the present invention, it is possible to provide a display system and a display system control method for enabling an infrared camera to capture a clear video.

### BRIEF DESCRIPTION OF DRAWINGS

FIG. 1 is a schematic view showing an example of a configuration of an LED display according to an embodiment of the present invention.

FIG. 2 is a block diagram schematically showing an example of a configuration of a camera control system according to an embodiment of the present invention.

FIG. 3 is a block diagram schematically showing configuration example 1 of an LED drive circuit.

FIG. 4 is a block diagram schematically showing configuration example 2 of the LED drive circuit.

FIG. 5 is a block diagram schematically showing configuration example 3 of the LED drive circuit.

FIG. 6 is a block diagram showing an example of a configuration of a camera control system according to an embodiment of the present invention.

FIG. 7 is a diagram for describing the effect of control by the camera control system of the present embodiment.

FIG. 8A is a diagram for describing the effect of adaptive correction by the camera control system of the present embodiment.

FIG. 8B is a diagram for describing the effect of adaptive correction by the camera control system of the present embodiment.

FIG. 8C is a diagram for describing the effect of adaptive correction by the camera control system of the present embodiment.

FIG. 9A is a diagram for describing an example of application to a signage display.

FIG. 9B is a diagram for describing an example of application to a signage display.

FIG. 9C is a diagram for describing an example of line-of-sight analysis.

FIG. 10 is a diagram showing a minimum configuration of a camera control system according to an embodiment of the present invention.

### DESCRIPTION OF EMBODIMENTS

FIG. 1 is a schematic view showing an example of a configuration of a light emitting diode (LED) display according to an embodiment of the present invention.

An LED element 1 shown in FIG. 1 is formed by incorporating three LED elements (a red LED element R LED, a green LED element G LED, and a blue LED element B LED) and one infrared LED element IR LED in a package 101. Among these, the three LED elements are elements for displaying a full-color video and the one infrared LED element IR LED is an element for causing an LED display 3 to function as a large infrared illumination device. That is, the LED element 1 of the present invention shown in FIG. 1 is different from a conventional LED element 1a (a conventional LED element in which only three LED elements are incorporated in an LED package 101) which is also shown in FIG. 1.

The LED display 3 shown in FIG. 1 includes a plurality of LED cabinets 2 arranged vertically and horizontally. The LED cabinet 2 is a component unit of the LED display 3 and is configured by, for example, arranging and mounting a plurality of LED elements 1 shown in FIG. 1 vertically and horizontally on a printed circuit board 201.

The printed circuit board 201 has, for example, wiring for driving the LED element R LED, the LED element G LED, the LED element B LED, and the LED element IR LED. Alternatively, the printed circuit board 201 may include drive circuits shown in FIGS. 3 to 5 for driving the LED element R LED, the LED element G LED, the LED element B LED, and the infrared LED element IR LED.

FIG. 2 is a block diagram schematically showing an example of a configuration of a camera control system according to an embodiment of the present invention.

The camera control system 100 includes an infrared camera 11, an infrared camera compatible display (a display device: the above-described LED display 3), and a personal computer (PC) 23 for content reproduction and infrared light emission amount adjustment.

The infrared camera 11 photographs a photography target. A video captured by the infrared camera 11 is sent to the PC 23 for content reproduction and infrared light emission amount adjustment.

The PC 23 for content reproduction and infrared light emission amount adjustment outputs a video signal representing a display video to the LED display 3 and also outputs a light emission amount adjustment instruction for adjusting an amount of light which is emitted from the infrared LED (the LED element IR LED). That is, the LED display 3 reproduces the display video output from the PC 23 for content reproduction and infrared light emission amount adjustment and emits light of the infrared LED on the basis of control by the PC 23 for content reproduction and infrared light emission amount adjustment.

According to the configurations shown in FIGS. 1 and 2 described above, in the infrared camera compatible LED display (the LED display 3), the infrared camera 11 captures a clear video by the infrared LED element IR LED being incorporated as well as the red, green, and blue LED elements (the LED element R LED, the LED element G LED, and the LED element B LED) for displaying a full-color video in the individual LED package 101 and employing the LED display 3 as a large infrared illumination device.

As described above, the printed circuit board 201 is required to include an LED drive circuit for driving the LED element R LED, the LED element G LED, the LED element B LED, and the infrared LED element IR LED so that a clear video is captured by the infrared camera 11. LED drive circuits 41 to 43 will be described with reference to FIGS. 3 to 5.

### (Regarding Operation of LED Drive Circuit 41)

A circuit for causing a uniform electric current to flow through the infrared LED element so that the drive circuit is simplified is provided as a method in which the LED drive circuit 41 (configuration example 1) drives the infrared LED element IR LED. Although the electric current is made uniform by limiting the electric current which flows into the infrared LED element IR LED with a resistor R in the present example, a constant current circuit may be used instead of the resistor R.

FIG. 3 is a block diagram schematically showing configuration example 1 of the LED drive circuit. Hereinafter, a configuration and an operation of the LED drive circuit 41 (configuration example 1) will be described in detail.

As shown in FIG. 3, the LED drive circuit 41 is configured to include drive circuits (an R LED driver, a G LED driver, and a B LED driver) for driving a plurality of LED elements 1, a MOSFET (electric field effect transistor)-P, a scan control circuit SCAN CTL, and a plurality of resistors R.

The LED drive circuit 41 generates a drive signal (a signal for driving a cathode electrode of each LED) assigned to each pixel on the basis of the number of pixel components of the LED display 3 in a matrix of m horizontal components×n vertical components. Here, m and n are the number of LED elements 1 in the horizontal direction (the number of columns) and the number of LED elements 1 in the vertical direction (the number of rows) in the LED display 3, i (=1 to m) represents a column number, and j (=1 to n) represents a row number.

In FIG. 3, two LED elements 1 of LED element 1(m−1, j) and LED element 1(m, j) are shown. One terminals (anode terminals) of the LED elements 1 are commonly connected to one line.

Also, the MOSFET-P has a drain terminal connected to the one line, a gate terminal connected to an output terminal of the scan control circuit SCAN CTL, and a source terminal connected to a power supply voltage VCS.

Also, in the LED drive circuit 41 shown in FIG. 3, each of the other terminals (cathode terminals) of the LED element R LED, the LED element G LED, and the LED element B LED in each LED element 1 is connected to one of output terminals Q0 to Q9 of the drive circuits (the R LED driver, the G LED driver, and the B LED driver). On the other hand, in the LED drive circuit 41 shown in FIG. 3, the other terminal (cathode terminal) of the infrared LED element IR LED in each LED element 1 is connected to one end of the resistor R. Also, the other end of the resistor R is grounded.

Output terminals of the scan control circuit SCAN CTL are connected to input terminals CTL of the drive circuits (the R LED driver, the G LED driver, and the B LED driver), respectively. Also, the scan control circuit SCAN CTL receives a scan control signal output by an infrared LED luminance control unit (to be described below with reference to FIG. 6) as an input and turns on the MOSFET-P in accordance with the scan control signal.

Also, in the LED drive circuit 41 shown in FIG. 3, the drive circuits (the R LED driver, the G LED driver, and the B LED driver) control luminance of the LED element R LED, the LED element G LED, and the LED element B LED by individually controlling an electric current which flows into each of the LED element R LED, the LED element G LED, and the LED element B LED constituting the plurality of LED elements disposed in a line in accordance with a luminance control signal included in a video signal, wherein each of the LED elements is configured to include an infrared LED.

On the other hand, in the LED drive circuit 41 shown in FIG. 3, the luminance of the infrared LED element IR LED is fixed by uniformly making an electric current after an electric current, which flows into each of the infrared LED elements IR LED constituting the plurality of LED elements disposed in a line, is limited by the resistor R, wherein each of the LED elements is configured to include the infrared LED element.

### (Regarding Operation of LED Drive Circuit 42)

As a method in which an LED drive circuit 42 (configuration example 2) drives infrared LED elements IR LED, electric currents of a plurality of infrared LED elements IR LED can be collectively controlled and brightness (luminance) of the plurality of infrared LED elements IR LED can be adjusted. In this example, a constant current circuit is configured to control the electric currents which flow into the infrared LED elements IR LED. The constant current circuit used here is set so that a constant current value can be controlled from outside of the circuit and is controlled by a CPU or the like. The brightness may be adjusted in conjunction with the infrared camera so that an intensity of illumination can be adjusted appropriately so that the infrared camera can capture a clear video. Also, when there are other infrared sensors or the like nearby, an amount of infrared light which is emitted can be adjusted appropriately to prevent the infrared sensor from malfunctioning.

FIG. 4 is a block diagram schematically showing configuration example 2 of the LED drive circuit. Hereinafter, a configuration and an operation of the LED drive circuit 42 (configuration example 2) will be described in detail.

As shown in FIG. 4, the LED drive circuit 42 is configured to include drive circuits (an R LED driver, a G LED driver, and a B LED driver) for driving a plurality of LED elements 1, a MOSFET (electric field effect transistor)-P, a scan control circuit SCAN CTL, a constant current control circuit CORRENT CTL, and a constant current circuit CONSTANT CURRENT CIRCUIT (one constant current circuit).

Also, hereinafter, parts which are the same as those in FIG. 3 are denoted by the same reference signs and description thereof will be omitted appropriately.

In the LED drive circuit 42 shown in FIG. 4, the other terminal (a cathode terminal) of the infrared LED element IR LED in each LED element 1 is connected to one end of the constant current circuit CONSTANT CURRENT CIRCUIT. The other end of the constant current circuit CONSTANT CURRENT CIRCUIT is grounded. Also, a control terminal of the constant current circuit CONSTANT CURRENT CIRCUIT is connected to an output terminal of the constant current control circuit CORRENT CTL.

That is, in the LED drive circuit 42 shown in FIG. 4, the constant current control circuit CORRENT CTL causes a constant current to flow through the constant current circuit CONSTANT CURRENT CIRCUIT in accordance with a luminance control signal included in control information received by the infrared LED luminance control unit 32 to be described below.

More specifically, the brightness adjustment system 20 (a display control system) to be described below performs adjustment so that an optimum video can be received by analyzing a video received from the infrared camera 11, controlling an electric current which flows into the infrared LED element IR LED in accordance with an exposure state of the video, and increasing or decreasing an amount of infrared light which is emitted from the infrared LED element IR LED. For example, the brightness adjustment system 20 performs adjustment so that an optimum video can be received by analyzing whether an exposure state of the video received from the infrared camera 11 is an overexposure state (a state in which the photography target is photographed to be bright) or an underexposure state (a state in which the photography target is photographed to be dark), expanding an imaging range shown between the overexposure state and the underexposure state, and increasing or decreasing an amount of infrared light which is emitted in the expanded imaging range (details will be described below with reference to FIG. 7).

That is, the constant current control circuit CORRENT CTL is controlled by the infrared LED luminance control unit 32, so that the luminance of the infrared LED elements IR LED is controlled by collectively controlling electric currents which flow into the infrared LED elements IR LED constituting the plurality of LED elements disposed in a line, wherein each of the LED elements is configured to include the infrared LED element.

### (Regarding Operation of LED Drive Circuit 43)

As a method in which the LED drive circuit 43 (configuration example 3) drives an infrared LED element IR LED, the infrared LED element IR LED is connected to a drive circuit (an LED driver) in a configuration similar to that of the circuit for driving the red, green, and blue LEDs of the LED display 3. According to this configuration, the brightness of the infrared LED element IR LED can be adjusted individually and the brightness of the infrared LED element IR LED can be adaptively adjusted in accordance with a photography target of the infrared camera. The brightness is adaptively adjusted to an appropriate intensity of illumination so that a clear video can be captured by the infrared camera in conjunction with the infrared camera. Also, when there are other infrared sensors or the like nearby, the amount of infrared light which is emitted can be adaptively and appropriately adjusted to prevent the infrared sensor from malfunctioning.

FIG. 5 is a block diagram schematically showing configuration example 3 of the LED drive circuit. Hereinafter, a configuration and an operation of the LED drive circuit 43 (configuration example 3) will be described in detail.

As shown in FIG. 5, the LED drive circuit 43 is configured to include drive circuits (an R LED driver, a G LED driver, a B LED driver, and an IR LED driver) for driving a plurality of LED elements 1, and a MOSFET (electric field effect transistor)-P and a scan control circuit SCAN CTL.

Hereinafter, parts that are the same as those in FIGS. 3 and 4 are denoted by the same reference signs and description thereof will be omitted appropriately.

In the LED drive circuit 43 shown in FIG. 5, each of the other terminals (cathode terminals) of the LED element R LED, the LED element G LED, the LED element B LED, and the infrared LED element IR LED in each LED element 1 is connected to any one of output terminals Q0 to Q9 of the drive circuits (the R LED driver, the G LED driver, the B LED driver, and the IR LED driver).

That is, in the LED drive circuit 43 shown in FIG. 5, the electric current which flows into the infrared LED is individually controlled in accordance with a luminance control signal included in control information received by the infrared LED luminance control unit 32 to be described below using the drive circuits (the R LED driver, the G LED driver, the B LED driver, and the IR LED driver) that individually control the electric current that flows into each of the red LED, the green LED, and the blue LED constituting the plurality of LED elements.

More specifically, the brightness adjustment system 20 (a display control system) to be described below performs adjustment so that an optimum video can be received by analyzing a video received from the infrared camera 11, controlling an electric current which flows into the infrared LED element IR LED in accordance with an exposure state of the video, and increasing or decreasing an amount of infrared light which is emitted from the infrared LED element IR LED. For example, the brightness adjustment system 20 performs adjustment so that an optimum video can be received by analyzing whether an exposure state of the video received from the infrared camera 11 is an overexposure state (a state in which the photography target is photographed to be bright) or an underexposure state (a state in which the photography target is photographed to be dark) and increasing or decreasing an amount of infrared light which is emitted in an imaging range shown in the overexposure state and the underexposure state (details will be described below with reference to FIGS. 8A, 8B, and 8C).

That is, the drive circuit (the IR LED driver) is controlled by the infrared LED luminance control unit 32, so that the luminance of the infrared LED element IR LED is controlled by individually controlling electric currents that flow into the infrared LED elements constituting the plurality of LED elements disposed in a line, wherein each of the LED elements is configured to include the infrared LED element. Also, the description of “the plurality of LED elements disposed in the line” represents a plurality of LED elements 1 disposed in a horizontal direction (j represents a certain direction shown in FIG. 6) in the LED display 3 (or the LED cabinet 2) shown in FIG. 1. Of course, the plurality of LED elements may be configured to include a plurality of LED elements 1 disposed in a vertical direction (i which is not shown in FIG. 6 represents a certain direction) or may be configured to include all m×n LED elements 1 disposed in the LED display 3. That is, a configuration in which the electric current which flows into the infrared LED element IR LED is “individually” controlled may include a configuration in which electric currents which flow into the infrared LED elements IR LED in all the m×n LED elements 1 disposed in the LED display 3 are “individually” controlled.

FIG. 6 is a block diagram showing an example of a configuration of the camera control system according to an embodiment of the present invention.

FIG. 6 is a diagram showing an example of a control method for use in the camera control system and shows an example of a control method to be applied to the LED drive circuit 42 (configuration example 2) and the LED drive circuit example 43 (configuration example 3) described above. Also, because the amount of light which is emitted from the infrared LED is fixed and is not controlled in the LED drive circuit 41 (configuration example 1), description thereof is omitted here.

The camera control system 100 is configured to include an infrared camera system 10 (a photography system), a brightness adjustment system 20 (a display control system), and an infrared camera compatible LED display system 30 (a display system).

The infrared camera system 10 is configured to include an infrared camera unit 11 (the infrared camera 11 shown in FIG. 2), an exposure detection unit 12, a central processing unit (CPU) 13, and an aperture/shutter speed control unit 14.

The infrared camera 11 photographs a subject (a photography target shown in FIG. 2).

The exposure detection unit 12 detects an exposure state of an image from a state of a video captured by the infrared camera 11.

The CPU 13 analyzes the exposure state detected by the exposure detection unit 12 and appropriately adjusts the aperture and the shutter speed using the aperture/shutter speed control unit 14 so that the exposure of the captured video is optimized.

The brightness adjustment system 20 is included in the PC 23 for content reproduction and infrared light emission amount adjustment described above. The CPU 21 in the brightness adjustment system 20 performs adjustment so that an optimum video can be received by analyzing a video received from the infrared camera system 10, controlling the infrared camera compatible LED display system 30 in accordance with an exposure state of the video, and increasing or decreasing an amount of infrared light which is emitted from the infrared camera compatible LED display system 30.

The infrared camera compatible LED display system 30 is configured to include a CPU 31, an infrared LED luminance control unit 32, a scan control unit 33, and an infrared LED unit 34 and constitutes features of the present invention. Here, the CPU 31 and the infrared LED luminance control unit 32 are included in the above-described PC 23 for content reproduction and infrared light emission amount adjustment. Also, the scan control unit 33 is the scan control circuit SCAN CTL in the LED drive circuits 41 to 43 shown in FIGS. 3 to 5 and may be provided on the printed circuit board 201 in the LED display 3. Also, the infrared LED unit 34 is the infrared LED element IR LED in the LED element 1 shown in FIGS. 1 and 3 to 5.

The CPU 31 is connected to the CPU 21 of the brightness adjustment system 20 and receives control information. The CPU 31 increases or decreases the luminance of the infrared element IR LED using the infrared LED luminance control unit 32 on the basis of the received information.

In the case of the LED drive circuit 43 (configuration example 3), the infrared LED luminance control unit 32 is connected to each infrared LED unit via the scan control unit 33 to individually control the luminance of each infrared element IR LED. The term “via the scan control unit 33” represents that the infrared LED luminance control unit 32 individually controls the luminance of the infrared element IR LED by controlling the scan control circuit SCAN CTL and the drive circuit (the IR LED driver) in FIG. 5.

Also, in the case of the LED drive circuit 42 (configuration example 2), there is no drive circuit (IR LED Driver) and the infrared LED luminance control unit 32 directly controls the luminance of the infrared element IR LED by performing control using the constant current circuit CONSTANT CURRENT CIRCUIT.

FIG. 7 is a diagram for describing the effect of control by the camera control system of the present embodiment.

In FIG. 7, the horizontal axis represents an available photography range of the infrared camera 11 and the vertical axis represents an exposure state in the captured video captured by the infrared camera 11. Also, in FIG. 7, a broken line 51 indicates a case in which the LED display is not controlled, i.e., a case in which the camera control system 100 does not control the luminance of the infrared LED element IR LED using the LED drive circuit 42 (configuration example 2) or the LED drive circuit 43 (configuration example 3). On the other hand, a solid line S2 indicates a case in which the LED display is controlled, i.e., a case in which the camera control system 100 controls the luminance of the infrared LED element IR LED using the LED drive circuit 42 (configuration example 2) or the LED drive circuit 43 (configuration example 3).

As indicated by the broken line 51 in FIG. 7, even if the infrared camera 11 performs adjustment so that an aperture and a shutter speed are appropriately adjusted and the exposure of a captured video is optimized using the aperture/shutter speed control unit 14, the exposure state of the captured video uniformly becomes an underexposure state (a state in which a photography target is photographed to be dark) on a left side of the available photography range (<RL1) in a case in which a subject is at a distant position (corresponding to a case in which an amount of infrared light is small). On the other hand, in a case in which the subject is at a near position (corresponding to a case in which the amount of infrared light is large), the exposure state of the captured video uniformly becomes an overexposure state (a state in which the photography target is photographed to be bright) on a right side of the available photography range (>RR1). That is, a range R1 indicated by a broken-line arrow at the center of FIG. 7 represents an available photography range provided in the infrared camera 11 when the luminance of the infrared LED element IR LED is not controlled by the LED drive circuit 42 (configuration example 2) and the LED drive circuit 43 (configuration example 3).

On the other hand, as indicated by a solid line S2 in FIG. 7, the amount of infrared light which is emitted is increased, i.e., the exposure state is uniformly maintained in a more underexposure state on the left side of the available photography range (<RL2), when the subject is at a distant position by controlling the luminance of the infrared LED element IR LED using the LED drive circuit 42 (configuration example 2) and the LED drive circuit 43 (configuration example 3). On the other hand, when the subject is at a near position, the amount of infrared light is decreased, i.e., the exposure state is uniformly maintained in a more overexposure state on the right side of the available photography range (>RR2). Thereby, the available photography range of the infrared camera 11 can be set to an available photography range R2 (a range indicated by a solid-line arrow at the center of FIG. 7) expanded from the available photography range (the range R1 indicated by the broken-line arrow at the center of FIG. 7) according to the aperture and the shutter speed.

That is, as in the camera control system 100 including the LED drive circuit 42 (configuration example 2) or the LED drive circuit 43 (configuration example 3), it is possible to adjust the infrared light emitted from a screen of the infrared camera compatible LED display system by controlling the luminance of the infrared LED and expand the photography range in addition to the available photography range according to the aperture and the shutter speed provided in the original infrared camera system.

That is, according to the camera control system 100 of the present embodiment, it is not necessary to provide an infrared illumination device in the infrared camera 11 and the infrared camera 11 can perform clear photography because an object (a photography target) can be illuminated by a large screen included in the LED display 3 (the LED display).

As described above, according to the camera control system 100 of the present embodiment, it is not necessary to provide an infrared illumination device in the infrared camera 11 and the infrared camera 11 can be miniaturized. Thus, the infrared camera 11 can be integrated with the LED display 3 (the LED display) or the infrared camera 11 can be installed in an inconspicuous place, so that it becomes unlikely for the photography target to notice the presence of the infrared camera 11 (the camera) and natural monitoring and investigations of the photography target are possible. Of course, even if the LED display 3 (the LED display) is not in operation, only the infrared illumination function can be operated and the infrared camera 11 can photograph the photography target.

Also, adaptive correction by the camera control system 100 of the present embodiment will be described. FIGS. 8A, 8B, and 8C are diagrams for describing the effect of adaptive correction by the camera control system of the present embodiment.

FIG. 8A is a diagram showing an “infrared-camera captured video.” Also, FIG. 8B is a diagram showing a “light emission state of the infrared element of the LED display (when adaptive correction is adjustable).” Also, FIG. 8C is a diagram showing an “infrared-camera captured video (when adaptive correction is adjustable).”

When the luminance of each infrared LED can be individually controlled as in the camera control system 100 including the LED drive circuit 43 (configuration example 3), the brightness adjustment system 20 can clearly capture a photography target without blown highlights or crushed shadows by adaptively setting the luminance of an individual infrared LED according to a result of analyzing a captured video captured by the infrared camera system 10.

For example, as in the “infrared-camera captured video” shown in FIG. 8A, a case in which a photography target 81 near the infrared camera compatible LED display system 30 has blown highlights (saturated to the white side) and a photography target 82 far from the infrared camera compatible LED display system 30 has crushed shadows (saturated to the black side) may be assumed.

In this case, in the light emission state of the infrared LED of the infrared camera compatible LED display system 30, an amount of light which is emitted from the infrared LED close to the blown highlight side is decreased (in a light emission state 91) and an amount of light which is emitted from the infrared LED close to the crushed shadow side is increased (in a light emission state 92) as in the “light emission state of the infrared element of the LED display (when adaptive correction is adjustable)” shown in FIG. 8B.

Thereby, it is possible to improve the sharpness of the video captured by the infrared camera 11 as in the photography target 81 and the photography target 82 in the “infrared-camera captured video (when adaptive correction is adjustable)” shown in FIG. 8C.

That is, it is possible to clearly photograph each of a plurality of photography targets even if distances between a plurality of photography targets and the LED display 3 (the infrared camera compatible LED display) constituting the infrared camera compatible LED display system are different by causing the above-described adaptive correction of the video captured by the infrared camera to be adjustable as a control means of the camera control system 100 of the present embodiment.

When a video is clear, it is easy to identify a line of sight of a photography target. A clear video can be utilized for various purposes of monitoring, crime prevention, investigation, and purchasing behavior, and the like.

For example, a signage display can be assumed for the purpose of utilizing a control means of the camera control system 100 of the present embodiment.

FIGS. 9A and 9B are diagrams for describing examples of application to a signage display. FIG. 9C is a diagram for describing an example of line-of-sight analysis.

FIGS. 9A and 9B show examples in which a camera control system 100a and a camera control system 100b are applied to the signage display.

The camera control system 100a shown in FIG. 9A includes an LED display 3a (a signage display) and a content reproduction personal computer (PC) 23a.

That is, the camera control system 100a does not include the infrared camera system 10 (the photography system), the brightness adjustment system 20 (the display control system), and the infrared camera compatible LED display system 30 (the display system) shown in FIG. 6.

Thus, in the camera control system 100a, the LED display 3a reproduces a video signal representing a display video output from the content reproduction PC 23a. However, the camera control system 100a cannot measure the number of lines of sight of advertisement targets (equivalent to the photography targets of the infrared camera 11 shown in FIG. 2) who view a reproduced display video (an advertising effect).

On the other hand, the camera control system 100b shown in FIG. 9B includes an infrared camera 11, an infrared camera compatible display (a display device: the above-described LED display 3), and a PC 23b for content reproduction and infrared light emission amount adjustment.

Here, the PC 23b for content reproduction and infrared light emission amount adjustment further includes a line-of-sight detection function and a line-of-sight analysis function synchronized with the content reproduction with respect to the PC 23 for content reproduction and infrared light emission amount adjustment shown in FIG. 2.

That is, the camera control system 100b is configured to include the infrared camera system 10 (the photography system), the brightness adjustment system 20 (the display control system), and the infrared camera compatible LED display system 30 (the display system) shown in FIG. 6. Further, the brightness adjustment system 20 (the display control system) is configured to include a line-of-sight detection unit and a line-of-sight count analysis unit.

Here, the line-of-sight detection unit detects a line of sight of an advertisement target (equivalent to a photography target of the infrared camera 11 shown in FIG. 2) who views a display video reproduced by the infrared camera compatible LED display system 30 (the display system) on the basis of the video captured by the infrared camera 11.

Also, the line-of-sight analysis unit can analyze the detected number of lines of sight with respect to each of a plurality of scenes constituting the display video.

Thereby, the camera control system 100b can measure the number of lines of sight of advertisement targets who view the reproduced displayed video (an advertising effect). FIG. 9C shows an example of this analysis result and effect. Also, as shown in FIG. 9C, it is assumed that content A/B/C is repeatedly reproduced as the display video. In FIG. 9C, a scene A-5 of content A has a large number of lines of sight indicating that an advertising effect is effective. Also, content B has not attracted lines of sight and shows a small advertising effect. Also, content C shows that the lines of sight are generally focused on content C and content C has a high advertising effect.

That is, the camera control system 100b can measure an effective scene by analyzing how many people have viewed a video displayed on the LED display 3 (the signage display) for how long in conjunction with display content of content so that the effect of advertisement displayed on the signage can be measured. Thereby, it is possible to make the operational effects of a signage appeal to advertisers or to set a fee or the like according to the effects.

Also, because the camera control system 100 and the camera control system 100b described above are premised on utilizing the infrared camera 11, monitoring and investigations in dark places can also be performed.

Next, a minimum configuration of the above-described embodiment will be described with reference to FIG. 10. FIG. 10 is a diagram showing a minimum configuration of a camera control system according to an embodiment of the present invention. As shown in FIG. 10, the camera control system 100 includes a brightness adjustment system 20 (a display control system) and an infrared camera compatible LED display system 30 (a display system).

The infrared camera compatible LED display system 30 (the display system) has the LED display 3 (the display device) that reproduces a display video and irradiates a photography target with infrared light. Also, the CPU 21 of the brightness adjustment system 20 (the display control system) analyzes the video captured by the infrared camera 11 and transmits control information representing that an amount of infrared light which is emitted in infrared light irradiation is to be adjusted in accordance with an exposure state of the video to the infrared camera compatible LED display system 30 (the display system). Here, the infrared camera compatible LED display system 30 (the display system) is configured to include the infrared LED luminance control unit 32 that controls the luminance of the infrared LED unit 34 (the infrared LED) that performs infrared light irradiation on the basis of the control information.

As described above, according to the embodiment and the minimum configuration example of the present invention, it is possible to provide a camera control system and a camera control method for enabling the infrared camera 11 to capture a clear video.

Also, according to the configuration of the display system, there is provided a display system including the infrared camera 11 (the camera) and the LED display 3 (the display device) configured to reproduce a display video and including the infrared LED unit 34 (the infrared light source). The display system includes the infrared LED luminance control unit 32 (the infrared luminance control unit) configured to control luminance of the infrared LED unit 34 in accordance with an exposure state of a video (a state of a video) captured by the infrared camera 11, so that it is possible to provide a display system and a display system control method for enabling the infrared camera 11 to capture a clear video.

Although embodiments of the present invention have been described above in detail with reference to the drawings, specific configurations are not limited to the embodiments and other designs and the like may be made without departing from the scope of the present invention. Also, some or all of programs to be executed by a computer of one or more CPUs or the like of the above-described embodiment can be distributed via a communication circuit or a computer-readable recording medium.

### REFERENCE SIGNS LIST

1, 1a LED element
2 LED cabinet
3, 3a LED display
10 Infrared camera system (photography system)
11 Infrared camera
12 Exposure detection unit
13, 21, 31 CPU
14 Aperture/shutter speed control unit
20 Brightness adjustment system (display control system)
23, 23a, 23b PC
30 Infrared camera compatible LED display system (display system)
32 Infrared LED luminance control unit
33 Scan control unit
34 Infrared LED unit (infrared LED)
41, 42, 43 LED drive circuit
101 Package
201 Printed circuit board

What is claimed is:

1. A display system comprising:
a camera;
a display device having an infrared light source; and
an infrared luminance control unit configured to control luminance of the infrared light source in accordance with a state of a video captured by the camera.

2. The display system according to claim 1, wherein the infrared luminance control unit controls the luminance of the infrared light source by collectively controlling electric currents which flow into infrared light sources using one constant current circuit configured to control an electric current which flows into each of the infrared light sources of a plurality of light emitting diode (LED) elements disposed in a line, each of the plurality of LED elements being configured to include the infrared light source.

3. The display system according to claim 1, wherein the infrared luminance control unit controls the luminance of the infrared light source by individually controlling electric currents which flow into infrared light sources using drive circuits configured to individually control electric currents which flow into a red LED, a green LED, and a blue LED constituting a plurality of LED elements disposed in a line, each of the plurality of LED elements being configured to include the infrared light source.

4. The display system according to claim 1, further comprising:
a line-of-sight detection unit configured to detect lines of sight of photography targets who view the display video reproduced by the display system on the basis of the video captured by the camera; and
a line-of-sight count analysis unit configured to analyze the number of lines of sight that have been detected with respect to each of a plurality of scenes constituting the display video.

5. The display system according to claim 1, further comprising:
a plurality of light emitting diode (LED) elements,
wherein the plurality of light emitting diode (LED) elements include light emitting diodes (LED) for emitting visible lights and the infrared light sources.

6. The display system according to claim 1, further comprising:
a video contents reproducing device.

7. The display system according to claim 6, further comprising:
a line-of-sight detection unit configured to detect a line of sight of a video, which is output of the video contents reproducing device, on the basis of the video captured by the camera.

8. The display system according to claim 1, wherein the camera comprises an infrared camera.

9. A method of controlling a display system:
wherein the display system includes a camera and a display device having an infrared light source,
wherein the display device includes an infrared luminance control unit, and
wherein the infrared luminance control unit controls luminance of the infrared light source in accordance with a state of a video captured by the camera.
